(19) United States
(12) Patent Application Publication
(10) Pub. No.: US 2009/0211445 A1
(43) Pub. Date: Aug. 27, 2009

(54) AMORPHOUS INFINITE COORDINATION POLYMER MICROPARTICLES AND USE FOR HYDROGEN STORAGE

(75) Inventors: Chad A. Mirkin, Wilmette, IL (US); You-Moon Jeon, Glenview, IL (US); Jungseok Heo, Glenview, IL (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: NORTHWESTERN UNIVERSITY, Evanston, IL (US)

(21) Appl. No.: 12/336,652

(22) Filed: Dec. 17, 2008

Related U.S. Application Data
(60) Provisional application No. 61/014,338, filed on Dec. 17, 2007.

(51) Int. Cl. B01D 53/02; C08G 63/02; B32B 5/16; C07F 3/06

(52) U.S. Cl. 95/130; 528/289; 428/402; 546/2; 95/90; 95/116

(57) ABSTRACT

Infinite coordination polymeric (ICP) materials are disclosed. One ICP material has a formula

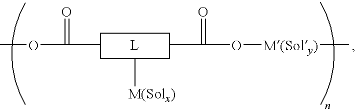

wherein —O(CO)-L-C(O)O— is the ligand, M and M′ are each a metal ion and are the same or different, Sol and Sol′ are each a solvent molecule and are the same or different, x and y are each selected from the group consisting of 0, 0.5, 1, 1.5, 2, 2.5, 3, and 3.5, and n is at least 100. Also disclosed are methods of making the ICP materials and methods of adsorbing a substance by contacting the ICP material with the substance. The substance can be a gas. Further disclosed is a crystalline metallo-ligand complex having a structure

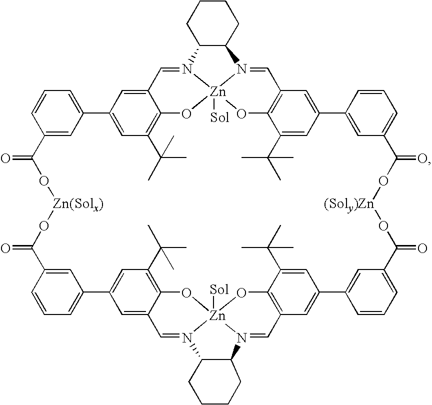

### CROSS REFERENCE TO RELATED APPLICATIONS

This application claims the benefit of U.S. Provisional Application No. 61/014,338, filed Dec. 17, 2007, the disclosure of which is incorporated herein by reference in its entirety.

### STATEMENT OF GOVERNMENT SUPPORT

This invention was made with U.S. government support under the Army Research Office (ARO) Grant No. W911NF-06-1-0116, National Science Foundation Grant No. CHE-0447674, and the Office of Naval Research Grant No. N00014-06-1-0078. The government has certain rights in this invention.

### BACKGROUND

Hydrogen gas (H₂) is considered an abundant, clean, environmentally friendly fuel and is therefore one of the most promising alternatives to hydrocarbon fuels (Schlapbach, et al., Nature, 414:353 (2001); Coontz, et al., Science, 305:957 (2004); and Rowsell, et al., Angew. Chem. Int. Ed., 44:4670 (2005)). One of the keys to being able to use hydrogen effectively in transportation and portable applications is the development of materials that allow one to effectively and safely store it. Many candidate materials have been studied for their H₂ storage capabilities, including metal hydrides (Bogdanovic, et al., Adv. Mater., 15:1012 (2003); Sandrock, et al., J. Alloys Compd., 330:696 (2002); and Grellier, et al., Angew. Chem. Int. Ed., 46:2613 (2007)), light hydrides (Schuth, et al., Chem Commun., 2249 (2004) and Graochala, et al., Chem. Rev., 104:1283 (2004)), carbon-based materials (Panella, et al., Carbon, 43:2209 (2005) and Zuttel et al., MRS Bull, 27:705 (2002)), organic microporous polymers (Fhanem, et al., Chem. Commun., 67 (2007); McKeown, et al., Chem. Soc. Rev., 35:675 (2007); McKeown, et al., Angew. Chem. Int. Ed., 45:1804 (2006); Cote, et al., Science, 310:1166 (2005); and El-Kaderi, et al., Science, 316:268 (2007)), and the crystalline metal-organic-frameworks (MOFs) (Humphrey, et al., Angew. Chem. Int. Ed., 46:272 (2007); Chen, et al., Inorg. Chem., 46:1233 (2007); Dinca, et al., J. Am. Chem. Soc., 127:9376 (2005); Rowsell, et al., J. Am. Chem. Soc., 128:1304 (2006); Bradshaw, et al., Acc. Chem. Res., 38:273 (2005); Chen, et al., Angew. Chem. Int. Ed., 44:4745 (2005); Zhao, et al., Science, 306:1012 (2004); Lee, et al., Angew. Chem. Int. Ed., 43:2798 (2004); Rosi, et al., Science, 300:1127 (2003); and Dybtsev, et al., J. Am. Chem. Soc., 126:32 (2004)). The MOFs are a particularly interesting class of materials because they have highly tailorable porosities and internal chemical functionalization. In addition, significant advances have been realized through the generation of structures that not only can selectively uptake H₂ in the presence N₂ but also differentiate other gases such as O₂ and CO₂ (Humphrey, et al., Angew. Chem. Int. Ed., 46:272 (2007); Chen, et al., Inorg. Chem., 46:1233 (2007); Dinca, et al., J. Am. Chem. Soc., 127:9376 (2005); Dybtsev, et al., J. Am. Chem. Soc., 126:32 (2004); and Ma, et al., Angew. Chem. Int. Ed., 46:2458 (2007)). A need exists for other materials that can store hydrogen and other gases.

### SUMMARY

The present disclosure is directed to infinite coordination polymer (ICP) materials of ligands and metal ions, and optionally one or more solvent molecules, wherein the ICP material is not crystalline and is capable of adsorbing a gas, and the ligand comprises two carboxylate moieties and at least one chelating moiety other than the two carboxylate moieties. The ICP material can be spherical. In various cases, when spherical, the ICP material has a diameter of about 0.1 to about 20 μm, about 0.5 μm to about 2 μm, about 0.8 μm to about 1.5 μm, or about 0.9 to about 1.2 μm. In some cases, the ICP material is capable of adsorbing at least 10 cm³ of a gas per gram of ICP material. In some specific embodiments, the ICP material can adsorb hydrogen.

In some embodiments, the ICP material has a formula

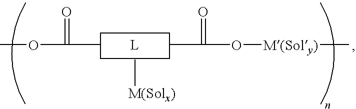

wherein —O(CO)-L-C(O)O— is the ligand, M and M′ are each a metal ion and are the same or different, Sol and Sol′ are each a solvent molecule and are the same or different, x and y are each selected from the group consisting of 0, 0.5, 1, 1.5, 2, 2.5, 3, and 3.5, and n is at least 100. In some specific embodiments, the metal ion is zinc, copper, nickel, and/or palladium. The solvent molecule can be pyridine, water, methanol, acetone, dimethyl formamide (DMF), dimethyl sulfoxide (DMSO), tetrahydrofuran (THF), acetonitrile, pyrimidine, ethanol, propanol, butanol, acetylacetate (acac), dimethylacetamide (DMA), imidazole, diethyl ether, methyl ethyl ketone, and/or diethyl formamide (DEF). In various cases, both M and M′ are zinc. In some cases, the ligand has a formula

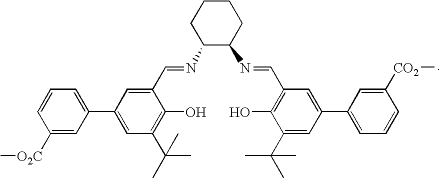

A further aspect is a method of adsorbing a substance comprising contacting the ICP material as disclosed herein with at least one substance. In some cases, the substance is a gas, and in a specific embodiment, the gas is hydrogen. The adsorption of hydrogen by the ICP material can be at least 50 cm³/g, or at least 60 cm³/g. In various cases, the ICP material adsorbs more hydrogen than nitrogen. In specific cases, the ICP material adsorbs at least 10 times more hydrogen than nitrogen.

Another aspect is a method of preparing the ICP materials as disclosed herein comprising admixing a ligand and a metal salt comprising the metal ion to form the ICP material, wherein the ligand to metal ion molar ratio is about 1:2. In some cases, the method further comprises drying the ICP material under vacuum.

Yet another aspect provides a metallo-ligand complex having a formula

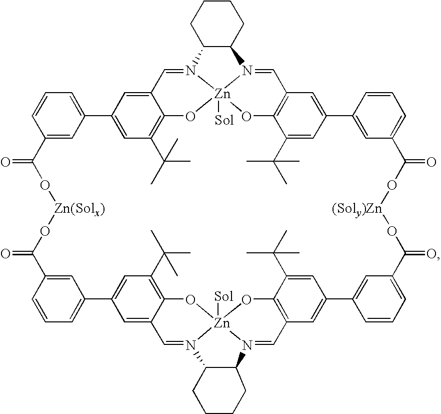

wherein the metallo-ligand complex is crystalline, each S is independently selected from pyridine, water, acetone, dimethyl formamide (DMF), dimethyl sulfoxide (DMSO), tetrahydrofuran (THF), acetonitrile, pyrimidine, ethanol, propanol, butanol, acetylacetone, dimethylacetamide (DMA), imidazole, dioxane, diethyl ether, methyl ethyl ketone, and/or diethyl formamide (DEF), and x and y are each independently selected from the group consisting of 0, 1, 2, and 3.

### BRIEF DESCRIPTION OF THE DRAWINGS

FIG. 1 shows a general scheme for preparing an infinite coordination polymer (ICP).

FIG. 2 shows a more specific synthetic scheme for preparing ICP materials or a crystalline metallo-ligand complexes, depending upon the solvents used.

FIGS. 3a and 3b are a field-emission scanning electron microscopy field-emission scanning electron microscopy (SEM) image and dark field optical microscopy image, respectively, of a ICP material as disclosed herein. The SEM images show the particles have a spherical shape with an average diameter of 0.997±0.182 μm

FIGS. 3c and 3d are a field-emission scanning electron microscopy field-emission scanning electron microscopy image and dark field optical microscopy image, respectively, of a crystalline metallo-ligand complex as disclosed herein.

FIG. 4a shows the crystal structure for a crystalline metallo-ligand complex as disclosed herein, and FIG. 4b shows a 3D packing diagram of the crystals of the metallo-ligand complex.

FIG. 5a shows a thermogravimetric analysis (TGA) of ICP material 3, crystalline metallo-ligand complex 4, and a comparison metallo-ligand particle 5.

FIG. 5b shows the X-ray diffraction patterns of crystalline metallo-ligand complex 4, as synthesized, as calculated, and after evacuation.

FIG. 6 shows the adsorption isotherms of nitrogen and hydrogen gas for ICP material 3 (hydrogen—filled diamonds, nitrogen—empty diamonds), crystalline metallo-ligand complex 4 (hydrogen—filled circles, nitrogen—empty circles), and comparison metallo-ligand particle 5 (hydrogen—filled triangles, nitrogen—empty triangles), as measured at 77 K.

### DETAILED DESCRIPTION

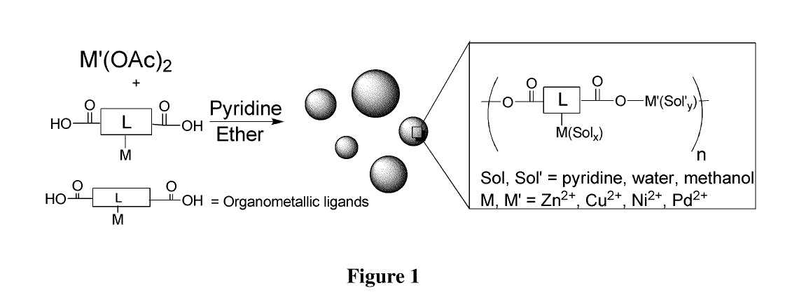

A new material, based upon an infinite coordination polymer (ICP), is a polymeric material that can be used for storing hydrogen gas. The ICP materials are prepared from ligands and metal ion connecting nodes (FIG. 1).

Disclosed herein are ICP materials comprising ligands and metal ions that are capable of storing gases. In some embodiments, the gases are selectively stored, e.g., the ICP material can uptake hydrogen gas while the ICP exhibits little or no uptake of nitrogen gas. Also disclosed herein are methods of storing and/or releasing a gas using the disclosed ICP materials. Further disclosed are methods of preparing the ICP materials. Also disclosed is a crystalline metallo-ligand complex.

There are a variety of ways of manufacturing ICP particles and related structures (Oh, et al., Nature, 438:651 (2005); Oh, et al., Angew. Chem. Int. Ed., 45:5492 (2006); Jeon, et al., J. Am. Chem. Soc., 129:7480 (2007); Maeda, et al., J. Am. Chem. Soc., 128:10024 (2006); Park, et al., J. Am. Chem. Soc., 128:8740 (2006); Wei, et al., Chem. Mater. 19:2987 (2005); and Sun, et al., J. Am. Chem. Soc., 127:13102 (2005)). Like MOFs, these structures are assembled via coordination chemistry principles, but in contrast to MOFs, the growth process is arrested at an early stage during polymerization, which results in their small size, and the resulting materials are amorphous, not crystalline. The ICP particles can be used for many applications due to (a) their high degree of tailorability through choice of transition metal nodes and ligand precursors; (b) high thermal stability, and (c) their readily accessible interior sites in solution.

Some ICP particles can be readily converted into other classes of particles through metal ion exchange without significantly changing the physical structure of the particles (Oh, et al., Nature, 438:651 (2005); and Oh, et al., Angew. Chem. Int. Ed., 45:5492 (2006)). The interior of the ICP particles, when dried, are accessible to gases, such as hydrogen.

ICP particles based on metallo-salen connector groups and Zn²⁺ nodes show moderately high H₂ uptake properties and almost no N₂ adsorption properties. This is despite the fact that these particles are amorphous and do not have the well-defined channels typically used to explain such selectivity in MOFs.

The term “not crystalline,” as used herein, refers to a material that is amorphous. Typically, an x-ray powder diffraction spectrum of a crystalline material has one or more sharp peaks, while an amorphous material has few or no sharp peaks in the x-ray powder diffraction spectrum.

A solvent molecule, as used herein, refers to a molecule that is typically used as a solvent in reactions or solutions. The solvent molecules can have a coordinating atom that allows for chelation to a metal ion, such as one or more of a nitrogen, oxygen, sulfur atom, or mixtures thereof. Non-limiting examples of solvent molecules include acetone, dimethyl formamide (DMF), dimethyl sulfoxide (DMSO), tetrahydrofuran (THF), acetonitrile, pyrimidine, ethanol, propanol, butanol, acetylacetone, dioxane, dimethylacetamide (DMA), imidazole, and/or diethyl formamide (DEF).

As used herein, a metal ion refers to a metal that is capable of coordinating with various organic and inorganic ligands. Exemplary metals include, but are not limited to, copper, zinc, nickel, cobalt, magnesium, calcium, strontium, barium, radium, manganese, chromium, vanadium, titanium, scandium, yttrium, zirconium, niobium, molybdenum, technetium, ruthenium, rhodium, palladium, silver, cadmium, lanthanum, hafnium, tantalum, tungsten, rhenium, osmium, iridium, platinum, gold, tin, cerium, aluminum, magnesium, calcium, strontium, barium, praseodymium, neodymium, promethium, samarium, europium, gadolinium, terbium, dysprosium, holmium, erbium, thulium, ytterbium, lutetium, or a mixture thereof. The metal ion can be in any oxidation state (e.g., zinc (II), copper (I), copper (II), nickel (I), nickel (II), palladium (II), manganese (III), manganese (V)) and can have any number of ligands coordinated in any coordination geometry (e.g., tetrahedral, square-planar, trigonal bipyramidal, square pyramidal, octahedral).

As used herein, a ligand refers to an organic or inorganic compound that is capable of coordinating to a metal ion, alternatively referred to herein as chelating to a metal ion. The ligands used herein typically have two carboxylate moieties and a third moiety capable of chelating to the metal ion. Chelating moieties typical comprise one or more heteroatoms, such as nitrogen, oxygen, sulfur, or combinations thereof. Examples of such moieties include, but are not limited to, ketones, ethers, amines, amides, imines, hydroxyls, sulfides, thioethers, thiocarboxylates, sulfamides, sulfones, sulfoxides, sulfonamides, and the like. One specific example of a ligand used herein is a salen ligand modified to have two carboxylate moieties, as shown in the following structure:

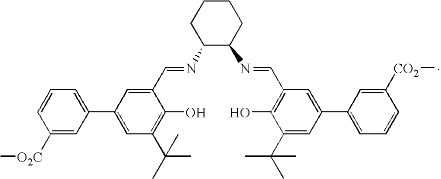

Alternatively, the salen ligand can have an ethylene backbone or dimethylethylene backbone, instead of a cyclohexyl backbone. Other contemplated ligands include cyclobutyl, cyclopentyl, dinaphthyl, propylene, methylene, phenyl, naphthyl, or adamnathyl ligands.

The ICP materials disclosed herein can have any shape or mixture of shapes. In various embodiments, the ICP material has a spherical shape. The diameter can be about 0.1 to about 20 μm. In some cases, the diameter of the ICP materials is about 0.5 μm to about 2 μm, about 0.8 μm to about 1.5 μm, or about 0.9 to about 1.2 μm.

The ICP materials disclosed herein can be used to adsorb a substance. The substance can be adsorbed by contacting the ICP material with the substance. Without being bound by theory, it is postulated that the porous ICP material is sufficient to adsorb a substance. The substance can be any compound, material, or mixture that is compatible with the ICP to be adsorbed. In some cases, the substance is a gas. Non-limiting examples of gases that can be adsorbed into the ICP materials disclosed herein include hydrogen, nitrogen, and methane.

In various embodiments, the adsorption of the gas by the ICP material is at least 10 cm³ of the gas per gram of the ICP material (cm³/g). The adsorption can be at least 15, at least 20, at least 25, at least 30, at least 35, at least 40, at least 45, at least 50, at least 55, or at least 60 cm³/g. The amount of gas that is adsorbed to the ICP material can be measured using a method as described in the below examples.

In some cases, the ICP material can selectively adsorb a specific gas when contacted with a mixture of gases. For example, a preferred gas can be adsorbed to the ICP material while an unpreferred gas is adsorbed to a lesser extent or not at all. The selectivity of the adsorption can be at least 2 times more, 3 time more, 4 times more, 5 times more, 6 times, more, 7 times more, 8 times more, 9 times more, 10 times more, 11 times more, 12 times more, 13 times more, 14 times more, or 15 times more of the preferred gas compared to the unpreferred gas, as measured by cm³/g. In one specific embodiment, the preferred gas is hydrogen and the unpreferred gas is nitrogen.

### EXAMPLES

### General Experimental Information

Solvents and all other chemicals were obtained from commercial sources and used as received unless otherwise noted. Deuterated solvents were purchased from Cambridge Isotope Laboratories Inc. and used as received. ¹H NMR spectra were recorded on a Varian Mercury 300 MHz FT-NMR spectrometer and referenced relative to residual proton resonances in pyridine-d₅ and DMSO-d₆. All chemical shifts are reported in ppm. Infrared spectra of solid samples (KBr pellets) were obtained on a Thermo Nicolet Nexus 670 FT-IR spectrometer. Emission spectra were obtained on a Jobin Yvon SPEX Fluorolog fluorometer using quartz cells (10×4 mm light path). Electrospray ionization mass spectra (ESI MS) were recorded on a Micromas Quatro II triple quadrupole mass spectrometer. Matrix assisted laser desorption ionization time-of-flight mass spectrometry (MALDI-TOF) was performed on samples with a Perseptive Biosystems Voyager Pro DE. Elemental analyses were done by Quantitative Technologies Inc., Whitehouse, N.J. BET experiments were performed by Quantachrome Instruments, Boynton, Fla. All scanning electron microscopy (SEM) images and energy dispersive X-ray (EDX) spectra were obtained using a Hitachi S-4500 cFEG SEM (Electron Probe Instruments Center (EPIC), NUANCE, Northwestern University) equipped with an Oxford Instruments EDS system. All optical and fluorescence microscopy images were obtained using a Zeiss Axiovert 100A inverted optical/fluorescence microscope (Thomwood, N.Y.) equipped with a Penguin 600CL digital camera (HQ FITC/Bopidy/Fluo3/Dio/EGFP filter set was used for green emission). Particle size and size distribution in solution were determined with a Zetasizer Nano-ZS instrument. X-ray crystal data were collected on a CCD area detector with graphite monochromated Mo Kα (λ=0.71073 Å) radiation with a Bruker SMART-1000 diffractometer.

### Synthesis of ICP Particles

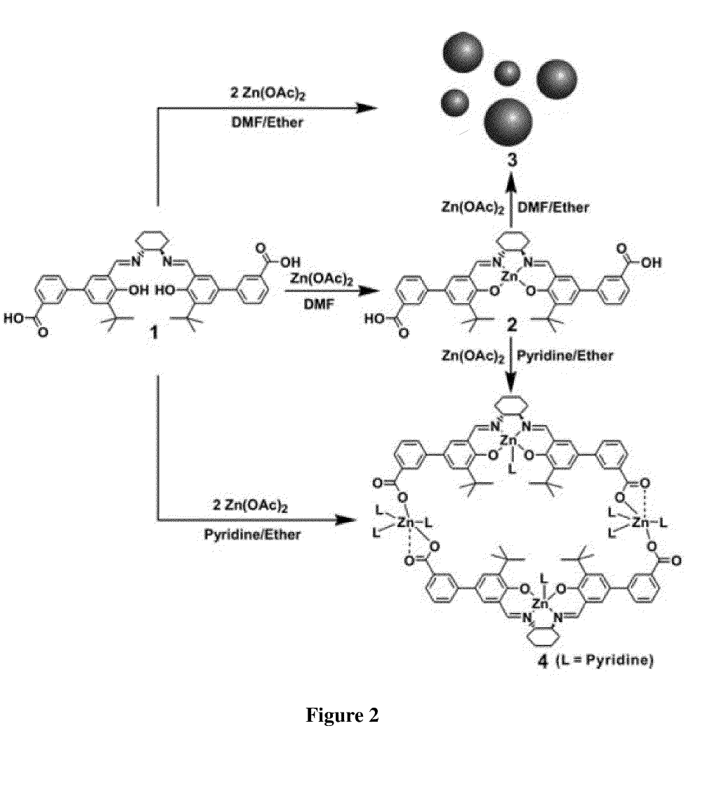

The synthetic scheme for a Salen-Zinc ICP is shown in FIG. 2. The homochiral acid-functionalized salen ligand (AFSL) 1 was synthesized by reacting the corresponding acid-functionalized salicylaldehyde and (1R,2R)-(−)-1,2-diaminocyclohexane according to literature procedures (Jeon, et al., Tetrahedron Lett., 48:2591 (2007)). The salen pocket of AFSL 1 was metallated with zinc acetate (Zn(OAc)₂) to form metallo-salen Zn(AFSL) 2 in dimethylformamide (DMF). AFSL 1 (100 mg, 148.1 μmol) and Zn(OAc)₂ (30 mg, 163.5 μmol) were combined in DMF (10 mL) and refluxed overnight. The solvent was removed under reduced pressure to yield a yellow precipitate. The product was resuspended in methanol and collected by filtration. This washing step was repeated three times. The product was then washed similarly with water and collected by filtration and dried under vacuum (106 mg, yield 97%). ¹H NMR (DMSO-d₆): δ 1.46 (br s, 11H, —C(CH₃)₃, —CH₂—), 1.85 (br s, 2H, —CH₂—), 3.21 (br s, 1H, —CH—), 7.38-7.44 (m, 3H, Ar—H), 7.68-7.78 (m, 2H, Ar—H), 8.12 (s, 1H, Ar—H), 8.46 (s, 1H, —CH═N—), 12.89 (br s, 1H, —CO₂H). IR (KBr pellet, cm⁻¹): 563 (w), 629 (w), 684 (w), 772 (m), 1089 (w), 1167 (w), 1270 (w), 1385 (s), 1410 (s), 1572 (s), 1626 (vs), 1658 (s), 2859 (w), 2931 (m). MS (MALDI-TOF, m/z)=736.37 (Calcd. for [2].(pyridine), C₄₇H₄₉N₃O₆Zn=815.295) and 894.36 (Calcd. for [2]·2(pyridine), C₅₂H₅₄N₄O₆Zn=894.33). Elemental analysis for C₄₂H₄₄N₂O₆Zn.2H₂O Calcd.: C, 65.16; H, 6.25; N, 3.62. Found: C, 64.94; H, 5.84; N, 3.77.

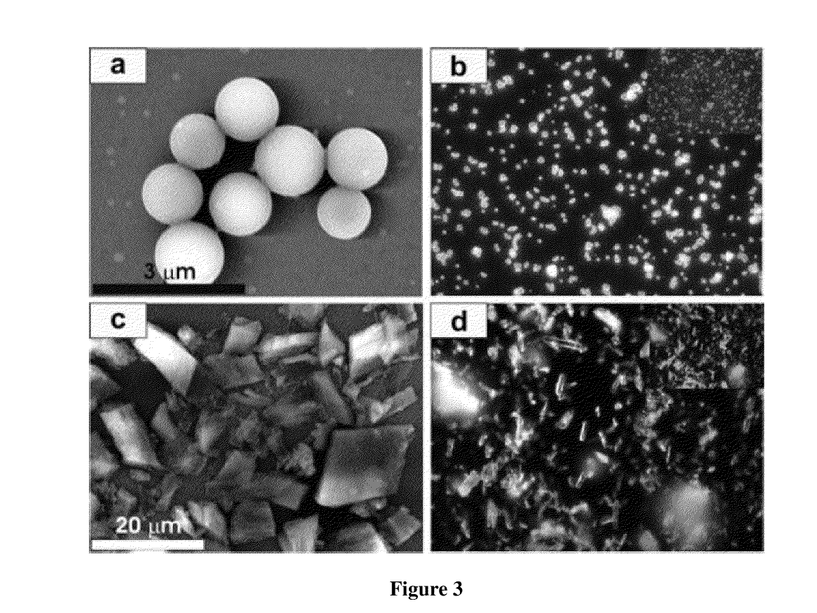

Compound 2 was used to prepare either an amorphous ICP particle 3 and a discrete [2+2] metallomacrocycle 4 based upon the addition of Zn²⁺ and the choice of solvent system (FIG. 2). When diethyl ether was slowly diffused into a 1:1 mixture of compound 2 and Zn(OAc)₂ in DMF, the amorphous coordination particles 3 formed at the interface and settled to the bottom of the reaction vessel. When compound 2 and Zn(OAc)₂ were dissolved in pyridine first, then diethyl ether was allowed to diffuse into the solution, yellow crystals of macrocyclic compound 4 formed (FIG. 3). Both the particles and the macrocycles were formed directly from the free base ligand 1 by using two equivalents of Zn(OAc)₂ rather than one and using the appropriate solvent mixture (FIG. 2).

ICP particle 3. A precursor solution was prepared by mixing 1 (20 mg, 29.6 μmol) and Zn(OAc)₂ (11 mg, 59.9 μmol) in DMF (10 mL). Diethyl ether was allowed to diffuse into the precursor solution overnight. The resulting precipitates were isolated and subsequently washed with toluene via centrifugation and redispersion cycles. Each successive supernatant was decanted and replaced with fresh toluene. The product was then dried under vacuum (19 mg, yield=80%). Microparticle 3 was synthesized using metallo-salen precursor 2 (20 mg, 27.1 μmol) and one equivalent of Zn(OAc)₂ (5 mg, 27.1 μmol) in DMF and ether (21 mg, yield=88%). IR (KBr pellet, cm⁻¹): 685 (w), 771 (w), 1165 (w), 1340 (w), 1363 (w), 1386 (s), 1409 (s), 1451 (m), 1562 (m), 1612 (vs), 2946 (m). MS (ESI taken after dissolving in pyridine, m/z)=894.55 (Calcd. for [2]·2(pyridine), C₅₂H₅₄N₄O₆Zn=894.33) and 957.58 (Calcd. for [2-H] Zn 2(pyridine), C₅₂H₅₅N₄O₆Zn₂=957.25). Elemental analysis for Zn(2-2H): Calcd.: C, 62.93; H, 5.28; N, 3.49. Found: C, 59.99; H, 5.22; N, 3.53. There are inherent difficulties in formulating the exact number of solvent (DMF and ether) and other guest molecules (toluene and water) in the particles due to the possibility of exchange during washing and centrifugation steps.

Metallomacrocycle 4. Diethyl ether was diffused into a pyridine solution of AFSL 1 (20 mg, 29.6 μmol) and Zn(OAc)₂ (11 mg, 59.9 μmol), which gave a yellow crystalline precipitate (17 mg, yield=70%). IR (KBr pellet, cm⁻¹): 698 (w), 771 (w), 1160 (w), 1383 (s), 1449 (m), 1556 (m), 1612 (vs), 1620 (vs), 2942 (w). MS (ESI taken after dissolving in pyridine, m/z)=895.17 (Calcd. for [2]·2(pyridine), C₅₂H₅₄N₄O₆Zn=894.33) and 957.09 (Calcd. for [2-H].Zn.2(pyridine), C₅₂H₅₅N₄O₆Zn₂=957.25). Elemental analysis for Zn(2-2H).5(pyridine) Calcd.: C, 65.50; H, 5.50; N, 6.31. Found: C, 65.84; H, 5.41; N, 5.91.

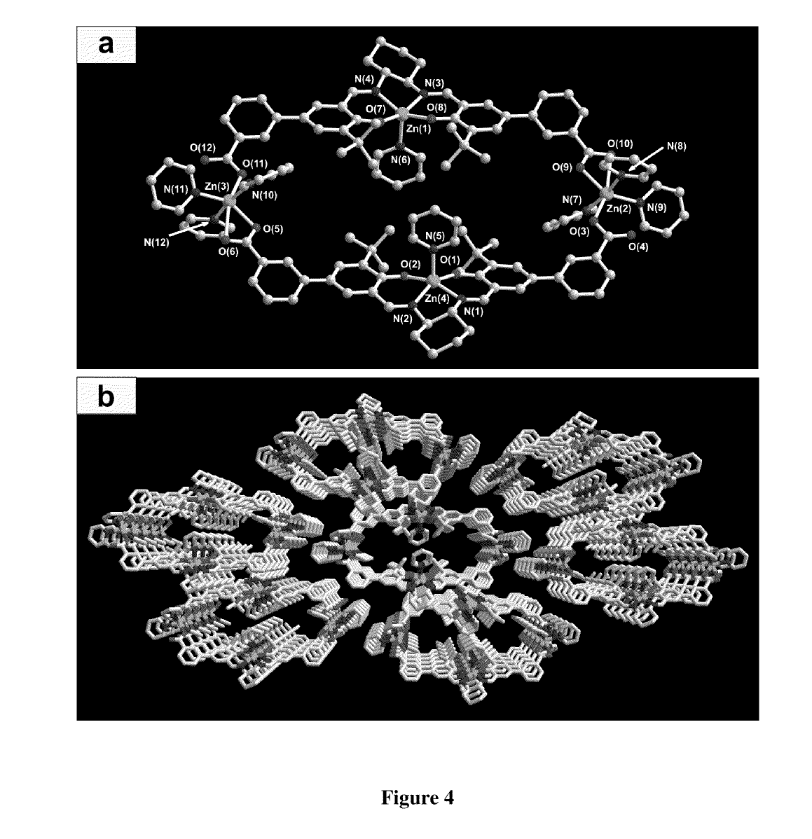

Crystals of 4 suitable for X-ray diffraction analysis were grown by the slow diffusion of diethyl ether into a pyridine solution of 2 and Zn(OAc)₂ (FIG. 2 and FIGS. 3c and 3d). Macrocycle 4 consists of two Zn(AFSL) 2 ligands which were connected by two Zn²⁺ metal ions to form a [2+2] metallomacrocycle (FIG. 4). The crystal data for 4 (CCDC-638761) was as follows: C₁₅₉H₁₆₀N₁₉O_{12.5}Zn₄. Triclinic, space group P(−)1, a=9.441(1) Å, b=15.476(2) Å, c=25.538(3) Å, a=92.895(2)°, β=95.013(2)°, γ=107.180(2)°, V=3539.8(7) Å³, Z=1, T=293(2) K, 2θₘₐₓ=57.7°, MoKα (λ=0.71073 Å), R₁=0.0523 (I>2σ(I)), wR₂=0.1282 (all data), and GOF on F²=0.906 for 1768 parameters and 28235 unique reflections.

Each connecting Zn²⁺ ion was in a distorted octahedral coordination geometry with three pyridine, one η¹-carboxylate, and one η²-carboxylate ligands with the following inter-atomic distances: Zn(2)-O(3) 1.978 Å, Zn(2) . . . O(4) 3.105 Å, Zn(2)-O(9) 2.040 Å, and Zn(2)-O(10) 2.559 Å. The coordination geometry of these bridging Zn²⁺ metal ions is similar to that observed for the monomeric model complex, (2,6-dichlorobenzoate)₂Zn(NC₅H₅)₃ (Darensbourg, et al., Inorg. Chem., 41:973 (2002)). The metal to metal distance of the two bridging Zn²⁺ ions, Zn(2) . . . Zn(3), is 20.832 Å. The Zn²⁺ ion in the salen pocket is in a square pyramidal geometry, and the four atoms that constitute the coordination plane of the salen pocket, N(1), N(2), O(1), and O(2), lie 0.43 Åbelow the central Zn(4) ion. A pyridine ligand is in the apical position. The Zn(4)-N(py) distance (2.123 Å) is slightly longer than the average Zn(4)-N(salen) distance (2.072 Å). These values are similar to those observed in a rac-1,2-cyclohexanediamino-N,N′-bis(3,5-di-tert-butylsalicylidene)zinc(II) complex: Zn—N(py) distance 2.108 Å, Zn—N(salen) distance 2.087 Å, and the Zn atom displacement from the coordination plane is 0.43 Å (Morris, et al., Inorg. Chem., 40:3222 (2001)). The two Zn²⁺ metals in each salen pockets, Zn(1) . . . Zn(4), are separated by 11.435 Å. The [2+2] metallomacrocycles 4 form stacks that are parallel to one another, which result in the formation of linear channels with one-dimensional accessibility (FIG. 4b). The average inter-plane distance for the two adjacent metallomacrocycles is 7.38 Å. There are seven free pyridine molecules in the unit cell, including two within the channels and five in-between them.

The micron-sized particles 3 were collected from the reaction mixture by centrifugation and washed with toluene several times. The ICP particle 3 is stable in most organic solvents (chloroform, methanol, acetone, DMF, DMSO, and non-polar hydrocarbons), water, and the dried state. The morphology of the particles was characterized by optical microscopy (OM), fluorescence microscopy (FM), and field-emission scanning electron microscopy (FE SEM) (FIGS. 3a and 3b). The SEM images show the particles have a spherical shape with an average diameter of 0.997±0.182 μm (FIG. 3a). The dynamic light scattering (DLS)-determined mean particle diameter of 1.195 μm is in agreement with the SEM determined value (0.997 μm). The DLS experiment was carried out in solution while the SEM was done under high vacuum, which can account for the 20% difference in the determined average size. Infrared spectra of the particles showed that the carboxylate groups were coordinating to Zn metal ions, as evidenced by a shift of the carboxylate stretching frequency from 1658 cm⁻¹ in Zn(AFSL) 2 to 1562 cm⁻¹ (νₐₙₜᵢ) and 1451 cm⁻¹ (ν_{sym}) for the ICP particles 3. These values compare well with the stretching frequencies for Zn(OAc)₂ at 1562 cm⁻¹ and 1446 cm⁻¹, consistent with η²-coordination of the carboxylate groups to the Zn²⁺ centers through their anionic O atoms. The chemical composition of 3 was determined by energy dispersive X-ray (EDX) spectroscopy and elemental analysis.

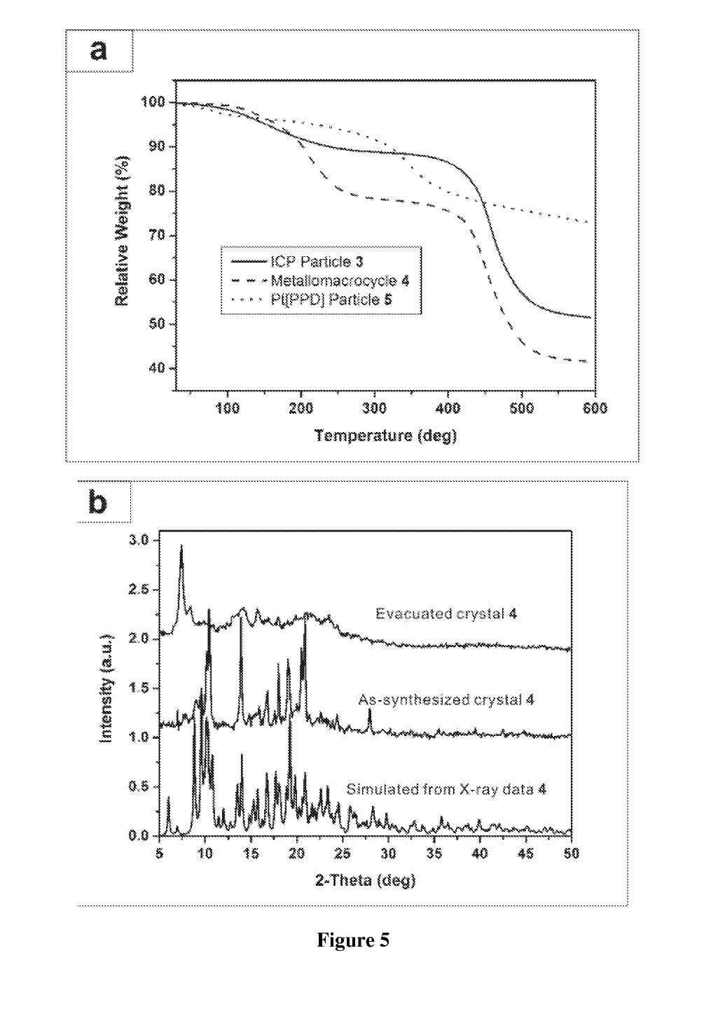

The thermal stabilities of ICP particle 3 and macrocycle 4 were measured by thermogravimetric analysis (TGA) under a nitrogen atmosphere (FIG. 5a). These data were compared with data from a similar experiment carried out for a Pt containing model ICP particle Pt[PPD] 5 (PPD=p-phenylenediamine).

The ICP 5 was synthesized according to literature procedures with average particle diameter of 0.547±0.066 μm by SEM analysis (Sun, et al., J. Am. Chem. Soc., 127:13102 (2007)). Colloidal Pt[PPD] particle 5 were prepared using H₂PtCl₆.6H₂O (358.2 mg, 0.69 mmol) and p-phenylenediamine (74.5 mg, 0.69 mmol) in water (700 mL) to give a black solid (136 mg). The Pt[PPD] particles were spherical with an average diameter of 547±66 nm (determined by FE-SEM).

The TGA data for 5 were obtained under nearly identical conditions. The TGA data reveal that with the exception of an initial weight loss (11.2%, presumably due to solvent liberation in the range of 100-250° C.), the ICP particles 3 are stable up to 400° C. The macrocycle 4 shows similar thermal behavior to the ICP particles, exhibiting an initial weight loss of 21.6%, which is close to the calculated value for the five pyridine molecules (19.8%) present at the start of the reaction (determined by elemental analysis). The difference between the number of solvent molecules in this experiment compared to the number observed by X-ray crystallography is due to the drying under vacuum of the macrocycles prior to the TGA analysis. The model complex 5 also exhibits this solvent weight loss (4.6%) during the early stages of the TGA experiment. X-ray powder diffraction data showed that the crystalline macrocycles 4 (after evacuation) decreased in crystallinity and the ICP particles 3 remained amorphous prior to the TGA studies (FIG. 5b).

### Hydrogen Gas Uptake by ICP Particles

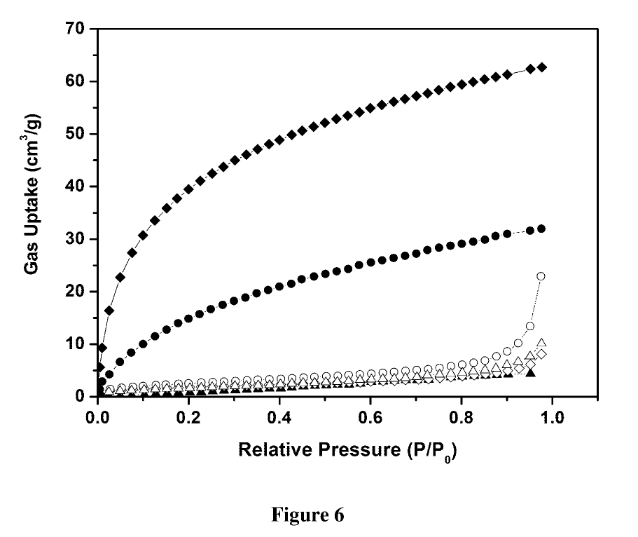

To measure the H₂ uptake and release properties of the amorphous ICP particle 3, a series of gas sorption experiments were carried out at 77 K after removal of solvent by thermal activation under a dynamic vacuum at 100° C. for 12 h (FIG. 6). Unexpectedly, the ICP particle 3, macrocycle 4, and Pt[PPD] particle 5 dis not show any notable nitrogen sorption properties. Therefore, the BET surface area of ICP particle 3 determined by the nitrogen isotherm is quite small, typically 6.52 m²/g, which compares well with the values for 4 (9.53 m²/g), 5 (6.26 m²/g), and the estimated surface area for nonporous polystyrene microspheres (ca. 5.66 m²/g; calculated from the density of polystyrene (1.06 g/cm³) and the average particle size (1 μm)).

Slow but significant hydrogen uptake was observed only for the ICP particle 3 under similar conditions. The sorption isotherms of H₂ for 3 and 4 reveal a type I behavior typical for microporous materials with a little hysteresis for 4 between the adsorption and desorption curves (FIG. 7). The H₂ uptake capability of 3 (63.0 cm³/g, 0.56 wt %) is comparable to that of the most favorable zeolite ZSM-5 (0.71 wt %) and the mesoporous material MCM-41 (0.57 wt %) at 77 K and 1 atm, but lower than those values determined for the well studied MOFs. The H₂ sorption capability of 3 is twice as large as that for crystalline 4 (32.2 cm³/g) and 13 times that for 5 (4.9 cm³/g). Since the H₂ sorption isotherm of 3 is not fully saturated, a higher adsorption capacity may be expected under higher pressure. Notably, there is no H₂ selectivity in Pt[PPD] particles 5, and in fact, no significant uptake even though the nodes are made of Pt. Such preferential adsorption for H₂ in amorphous particles is unprecedented but has been observed in a few crystalline microporous MOFs: Ni₈(5-bbdc)₆(μ3-OH)₄ (5-bbdc=5-tert-butyl-1,3-benzenedicarboxylate), Cu(FMA)(4,4′-Bpe)_{0.5}.0.5H₂O (FMA=fumarate, 4,4′-Bpe=trans-bis(4-pyridyl)ethylene), [CO₃(2,4-pdc)₂(μ3-OH)₂].9H₂O (2,4-pdc=2,4-pyridinedicarboxylate), Mn(HCO₂)₂, and Mg₃(NCD), where NCD=2,6-naphthalenedicarboxylate.

The foregoing describes and exemplifies the invention but is not intended to limit the invention defined by the claims which follow. All of the methods disclosed and claimed herein can be made and executed without undue experimentation in light of the present disclosure. While the materials and methods of this invention have been described in terms of specific embodiments, it will be apparent to those of skill in the art that variations may be applied to the materials and/or methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those of ordinary skill in the art are deemed to be within the spirit, scope and concept of the invention as defined by the appended claims.

What is claimed:

1. A polymeric material comprising metal ions and ligands and optionally one or more solvent molecules coordinated to the metal ions, wherein the polymeric material is amorphous and is capable of adsorbing a gas, and the ligand comprises two carboxylate moieties and at least one chelating moiety other than the two carboxylate moieties.

2. The polymeric material of claim 1, wherein the polymeric material is capable of adsorbing at least 10 cm³ of the gas per gram.

3. The polymeric material of claim 1 having a formula 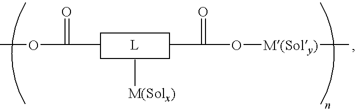
wherein —O(CO)-L-C(O)O— is the ligand, M and M′ are each a metal ion and are the same or different, Sol and Sol′ are each a solvent molecule and are the same or different, x and y are each selected from the group consisting of 0, 0.5, 1, 1.5, 2, 2.5, 3, and 3.5, and n is at least 100.

4. The polymeric material of claim 3, wherein each M and M′ are independently selected from the group consisting of copper, zinc, nickel, cobalt, radium, manganese, chromium, vanadium, titanium, scandium, yttrium, zirconium, niobium, molybdenum, technetium, ruthenium, rhodium, palladium, silver, cadmium, lanthanum, hafnium, tantalum, tungsten, rhenium, osmium, iridium, platinum, gold, tin, cerium, aluminum, magnesium, calcium, strontium, barium, praseodymium, neodymium, promethium, samarium, europium, gadolinium, terbium, dysprosium, holmium, erbium, thulium, ytterbium, and lutetium.

5. The polymeric material of claim 3, wherein each M and M′ are independently selected from the group consisting of zinc, copper, nickel, and palladium.

6. The polymeric material of claim 3, wherein M and M′ are the same.

7. The polymeric material of claim 1, wherein the ligand has a formula

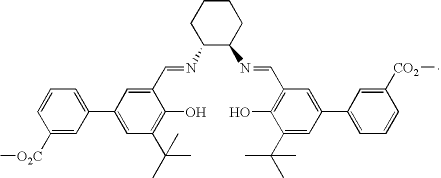

8. The polymeric material of claim 1 having a spherical form.

9. The polymeric material of claim 8, wherein the polymeric material has a diameter of about 0.1 μm to about 20 μm.

10. The polymeric material of claim 3, wherein each Sol and Sol′ is independently selected from the group consisting of pyridine, water, diethyl ether, and methanol.

11. A method of adsorbing a substance comprising contacting the polymeric material of claim 1 with the at least one substance.

12. The method of claim 11, wherein the substance is a gas.

13. The method of claim 12, wherein the gas is hydrogen.

14. The method of claim 13, wherein the adsorption of hydrogen by the polymeric material is at least 50 cm³ hydrogen per gram of polymeric material.

15. The method of claim 14, wherein the adsorption of hydrogen is at least 60 cm³/g.

16. The method of claim of 13, wherein the polymeric material adsorbs hydrogen to a greater extent than it adsorbs nitrogen.

17. The method of claim 16, wherein the polymeric material adsorbs at least 10 times more hydrogen than nitrogen.

18. A metallo-ligand complex having a formula 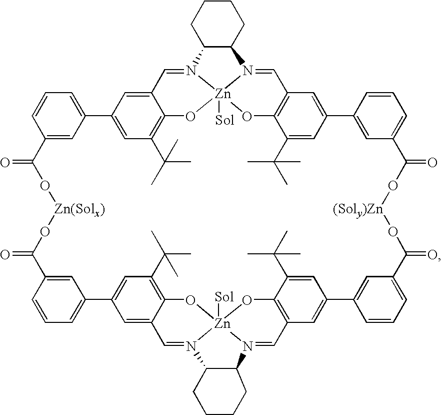
wherein the metallo-ligand complex is crystalline, each Sol is independently selected from pyridine, water, and dimethyl formamide, and x and y are each independently selected from the group consisting of 0, 1, 2, and 3.
